(19) United States
(12) Patent Application Publication
(10) Pub. No.: US 2025/0012302 A1
(43) Pub. Date: Jan. 9, 2025

(54) EMERGENCY DESCENT SYSTEM FOR AERIAL WORK PLATFORM AND CONTROL METHOD THEREOF

(71) Applicant: HUNAN SINOBOOM INTELLIGENT EQUIPMENT CO., LTD., Changsha (CN)

(72) Inventors: Guoliang LIU, Changsha (CN); Wei SHI, Changsha (CN); Junbo ZHAO, Changsha (CN); Yuxiao ZHANG, Changsha (CN)

(73) Assignee: HUNAN SINOBOOM INTELLIGENT EQUIPMENT CO., LTD., Changsha (CN)

(21) Appl. No.: 18/889,822

(22) Filed: Sep. 19, 2024

Related U.S. Application Data
(63) Continuation of application No. PCT/CN2022/119592, filed on Sep. 19, 2022.

(30) Foreign Application Priority Data
Aug. 17, 2022 (CN) 202210987394.9

(51) Int. Cl. F15B 20/00; B66F 11/04; B66F 17/00

(52) U.S. Cl. CPC F15B 20/008; B66F 11/044; B66F 17/006; F15B 2211/8636; F15B 2211/8757

(57) ABSTRACT

An emergency descent system for an aerial work platform includes a telescopic hydraulic cylinder provided a piston rod inside, a counterbalance valve, an oil return pipe and a proportional valve. An interior of the telescopic hydraulic cylinder is divided into a cavity with rod and a cavity with non-rod. An inlet of the counterbalance valve is connected to the cavity with non-rod, and an outlet of the counterbalance valve is connected to an oil supply pipe. The oil return pipe is connected to the cavity with rod and a control port of the counterbalance valve, the oil return pipe is connected to an emergency oil source which is used for providing hydraulic oil to the oil return pipe. An inlet of the proportional valve is connected to the cavity with non-rod, and an outlet of the proportional valve is connected to the oil return pipe.

### CROSS-REFERENCE TO RELATED APPLICATIONS

The present application is a continuation of International Application No. PCT/CN2022/119592, filed on Sep. 19, 2022, which claims priority to Chinese Patent Application No. 202210987394.9, filed on Aug. 17, 2022. The disclosures of the aforementioned applications are hereby incorporated by reference in their entireties.

### TECHNICAL FIELD

The present disclosure relates to the field of aerial work platform technologies, and in particular, to an emergency descent system for an aerial work platform and a control method thereof.

### BACKGROUND

At present, aerial work platforms are special purpose vehicles for transporting workers and use equipment to high altitude to install, maintain and clean devices in high altitude. Compared with traditional operation modes, such as setting up scaffolds and ladders, the aerial work platforms have advantages of a good operation performance, a high operation efficiency and safety in operation and the like, and are widely applied to infrastructure industries such as electric power, traffic, petrochemical, communication, gardening and the like. When a boom of the aerial work platform is luffing down by gravity, oil in a cavity with non-rod of a lift cylinder passes through a two-position two-way switch valve, a directional-control valve, a proportional valve and a compensator, and returns to a hydraulic oil tank. In a process of using, the two-position two-way switch valve and the proportional valve which are used for controlling the boom to be luffing down by the gravity may be stuck, resulting in that a valve core cannot be normally shifted, and a wiring harness is scratched with a structure of the boom, then resulting in damage or fracture of the wiring harness, and thus an electrical signal cannot be transmitted normally. This will make the oil in the lift cylinder unable to be circulated and returned, resulting in that the workers cannot descend safely from air to ground.

### SUMMARY

The present disclosure aims at solving at least one of the technical problems existing in conventional technologies. In view of this, the present disclosure provides an emergency descent system for an aerial work platform, which enable workers to descend safely from air to ground descend.

According to an embodiment of a first aspect of the present disclosure, an emergency descent system for an aerial work platform includes: a telescopic hydraulic cylinder, a counterbalance valve, an oil return pipe and a proportional valve. A piston rod for lifting a load is provided inside the telescopic hydraulic cylinder, and an interior of the telescopic hydraulic cylinder is divided into a cavity with rod and a cavity with non-rod by the piston rod. An inlet of the counterbalance valve is connected to the cavity with non-rod, and an outlet of the counterbalance valve is connected to an oil supply pipe. The oil return pipe is connected to the cavity with rod, the oil return pipe is connected to an emergency oil source which is used for providing hydraulic oil to the oil return pipe, and the oil return pipe is connected to a control port of the counterbalance valve. An inlet of the proportional valve is connected to the cavity with non-rod, and an outlet of the proportional valve is connected to the oil return pipe.

The emergency descent system for the aerial work platform according to an embodiment of the present disclosure at least has the following beneficial effects: The proportional valve may be opened, to make the hydraulic oil in the cavity with non-rod enter the cavity with rod to control the piston rod to descend. When the proportional valve fails, the piston rod may also be controlled to descend through the counterbalance valve. A load is controlled to descend through two control modes. When one control mode fails, the other control mode may be used for controlling the load to descend, so that safety of an aerial operation is effectively improved.

According to some embodiments of the present disclosure, a switch valve is connected between the proportional valve and the cavity with non-rod, for connecting and closing an oil path between the proportional valve and the cavity with non-rod.

According to some embodiments of the present disclosure, the switch valve is a two-position, two-way and two-way cut-off switch valve, the inlet of the counterbalance valve is connected to a first check valve, the first check valve is connected to the oil supply pipe, the hydraulic oil is capable of flowing from the oil supply pipe to the cavity with non-rod through the first check valve, and the first check is configured to prevent the hydraulic oil from flowing back to the oil supply pipe from the cavity with non-rod.

According to some embodiments of the present disclosure, the inlet of the proportional valve is connected to a second check valve, the second check valve is connected to the oil supply pipe, the hydraulic oil is capable of flowing from the oil supply pipe to the first check valve through the second check valve, and the second check valve is configured to prevent the hydraulic oil from flowing back to the oil supply pipe from the switch valve.

According to some embodiments of the present disclosure, a compensator is connected between the outlet of the proportional valve and the oil return pipe.

According to some embodiments of the present disclosure, the emergency oil source may adjust a pressure of the hydraulic oil provided to the oil return pipe, to control an opening degree of the counterbalance valve.

According to some embodiments of the present disclosure, the proportional valve is electrically connected to a controller, the controller includes an obtaining module, a first control module and a second control module, where the obtaining module is configured to obtain a movement speed of the piston rod, the first control module is configured to control opening degrees of the proportional valve and the switch valve according to a speed obtained by the obtaining module, and the second control module is configured to control start and stop of the emergency oil source and a pressure of the hydraulic oil output by the emergency oil source according to the speed obtained by the obtaining module.

The present disclosure further provides a control method of an emergency descent system for the aerial work platform which includes the following steps.
S1: Adjusting, by a controller, an opening degree of the proportional valve to minimum, and switching, by the controller, a switch valve to an on position, then gradually increasing the opening degree of the proportional valve.
S2: Detecting, by the controller, a movement speed of the piston rod, and controlling, by the controller, the opening degree of the proportional valve, start and stop of the emergency oil source and a pressure of the hydraulic oil output by the emergency oil source according to the movement speed of the piston rod.

According to some embodiments of the present disclosure, in step S2, when the movement speed of the piston rod increases with increase of the opening degree of the proportional valve, continuing increasing the opening degree of the proportional valve until the movement speed of the piston rod reaches a preset value. When the opening degree of the proportional valve is increased, but the movement speed of the piston rod is zero or remains unchanged, starting, by the controller, the emergency oil source, to gradually increase a pressure of the hydraulic oil flowing to an oil return pipe until the movement speed of the piston rod reaches a preset value.

The emergency descent system for the aerial work platform according to an embodiment of the present disclosure has at least the following beneficial effects.

Firstly, on a basis of using the proportional valve to control a descending action, the standby emergency oil source and the counterbalance valve are added. When the proportional valve or the switch valve fails, the counterbalance valve may be used for exporting the hydraulic oil in the cavity with non-rod to control the load to descend.

Secondly, the emergency oil source provides the hydraulic oil to the control port of the counterbalance valve and the cavity with rod at the same time, when the load is too small to descend by its own weight, the hydraulic oil in the cavity with rod may push the piston rod to retract to achieve descent of the load.

Additional aspects and advantages of the present disclosure will be set forth in the following description, and will become apparent from the following description, or may be learned by a practice of the present disclosure.

### BRIEF DESCRIPTION OF THE DRAWINGS

The following further describes the present disclosure with reference to the drawings and embodiments.

FIG. 1 is a schematic diagram of an emergency descent system for an aerial work platform according to an embodiment of the present disclosure.

FIG. 2 is a flowchart a control method of an emergency descent system for an aerial work platform according to an embodiment of the present disclosure.

FIG. 3 is a structural block diagram of a controller according to an embodiment of the present disclosure.

### DETAILED DESCRIPTION OF THE EMBODIMENTS

Embodiments of the present disclosure are described in detail below, and examples of the embodiments are shown in the drawings, in which the same or similar reference symbol represents the same or similar element or element having the same or similar function throughout. The embodiments described below with reference to the drawings are exemplary and are merely for explaining the present disclosure, and should not be construed as a limitation for the present disclosure.

In the description of the present disclosure, it should be understood that the description involved in orientation, for example, orientation or positional relationship indicated by above and below and the like, is based on the orientation or position relationship shown in the drawings, and is merely to facilitate describing the present disclosure and simplify the description, rather than to indicate or imply that an apparatus or an element referred to must have a specific orientation, or be constructed and operated in a specific orientation. Therefore, it cannot be understood as a limitation for the present disclosure.

In the description of the present disclosure, a plurality of refers to more than two. If there are descriptions about the first and the second, they are merely used for a purpose of distinguishing technical features, and cannot be understood as indicating or implying relative importance, or implicitly indicating a quantity of the indicated technical features, or implicitly indicating a sequence of the indicated technical features.

In the description of the present disclosure, unless otherwise specified, words such as provide, install and connect should be understood in a broad sense, and a person skilled in the art may reasonably determine specific meanings of foregoing words in the present disclosure by referring to specific contents of technical solutions.

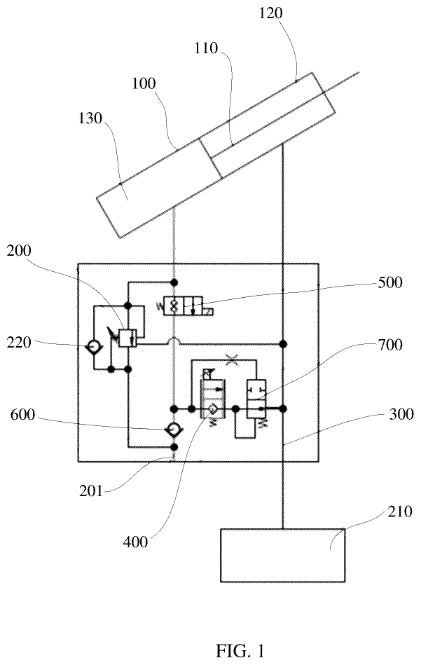

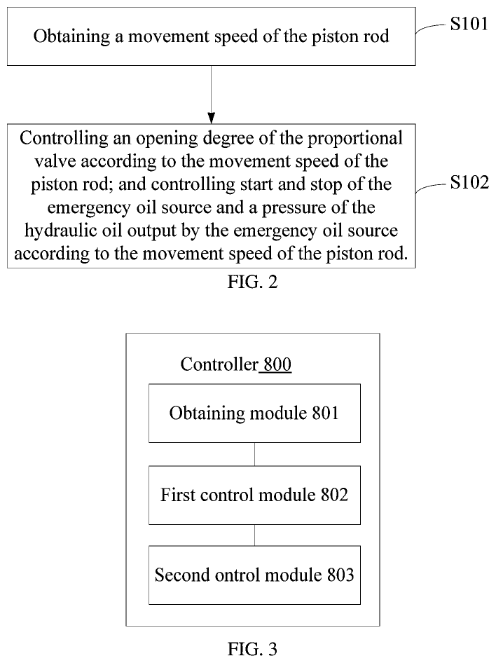

As shown in FIG. 1 of the specification, an emergency descent system for an aerial work platform provided by an embodiment of the present disclosure includes: a telescopic hydraulic cylinder 100, a counterbalance valve 200, an oil return pipe 300 and a proportional valve 400. A piston rod 110 is provided inside the telescopic hydraulic cylinder 100 for lifting a load, and the piston rod 110 is capable of moving along an inner wall of the telescopic hydraulic cylinder 100. An interior of the telescopic hydraulic cylinder 100 is divided into a cavity with rod 120 and a cavity with non-rod 130 by a piston at an end of the piston rod 110. An end of the piston rod 110 away from the piston is connected to loads such as a boom and the aerial work platform and the like. An inlet of the counterbalance valve 200 communicates with the cavity with non-rod 130 through a hydraulic pipeline, and an outlet of the counterbalance valve 200 is connected to an oil supply pipe 201 through a hydraulic pipeline. The oil return pipe 300 is connected to the cavity with rod 120, and the oil return pipe 300 is connected to an emergency oil source 210 which is used for providing hydraulic oil for the oil return pipe 300. The oil return pipe 300 is connected to a control port of the counterbalance valve 200. After the emergency oil source 210 is started, it provides the hydraulic oil to the oil return pipe 300, a pressure of the hydraulic oil in the oil return pipe 300 is capable of controlling the counterbalance valve 200 to be opened. The piston rod 110 is subjected to a combined action of a gravity and the pressure of the hydraulic oil in the cavity with rod 120, to squeeze the hydraulic oil in the cavity with non-rod 130 to make the hydraulic oil enter the cavity with rod 120 from the cavity with non-rod 130 through the counterbalance valve 200. In this way, the hydraulic oil flows out of in the cavity with non-rod 130, and the hydraulic oil flows in the cavity with rod 120, thereby the retraction of the piston rod 110 and the load is realized. The emergency oil source 210 should be kept in a standby state in normal use. When the proportional valve 400 fails, which results in the loads such as the aerial work platform cannot descend, the emergency oil source 210 will be switched from the standby state to a starting state, to provide the hydraulic oil to the control port of the counterbalance valve 200 and the cavity with rod 120. The counterbalance valve 200 is capable of keeping a flow rate of the hydraulic oil flowing through the counterbalance valve 200 basically unchanged under a condition that the loads change, thereby it is effectively ensured that the piston rod 110 is moved downwards at a uniform speed in the telescopic hydraulic cylinder 100 by using the counterbalance valve 200, and thus the load descends at a uniform speed. The inlet of the proportional valve 400 is connected to the cavity with non-rod 130, and the outlet of the proportional valve 400 is connected to the oil return pipe 300. Specific structures of the counterbalance valve 200 and the proportional valve 400 are conventional technologies, and will not be described in detail. After the proportional valve 400 is opened, the piston rod 110 is subjected to gravity to squeeze the hydraulic oil in the cavity with non-rod 130, to make the hydraulic oil enter the oil return pipe 300 from the cavity with non-rod 130 through the proportional valve 400. Since the cavity with rod 120 communicates with the oil return pipe 300, a portion of the hydraulic oil will enter the cavity with rod 120, so that the retraction of the piston rod 110 and the load is realized. When descending, the proportional valve 400 is preferentially opened to control the load to descend. When the proportional valve 400 fails, the counterbalance valve 200 is controlled to make the load descend. The load is controlled to descend by two control modes, when one control method fails, the other control method may be used for controlling the load to descend, thereby the safety of the aerial operation is effectively improved.

Referring to FIG. 1, it may be understood that a switch valve 500 is connected between the proportional valve 400 and the cavity with non-rod 130, for connecting and closing an oil path between the proportional valve 400 and the cavity with non-rod 130. The switch valve 500 has a good sealing performance. When it is not necessary to descend, the switch valve 500 is in a closed state, to prevent the hydraulic oil in the cavity with non-rod 130 from passing through the proportional valve 400, so that the load such as the aerial work platform is capable of being kept in the air for performing an aerial operation without descending.

Referring to FIG. 1, it should be understood that the switch valve 500 is a two-position, two-way and two-way cut-off switch valve. When the switch valve 500 is in the closed state, the hydraulic oil cannot flow from the cavity with non-rod 130 to the inlet of the proportional valve 400 and cannot flow from the inlet of the proportional valve 400 to the cavity with non-rod 130. The inlet of the counterbalance valve 200 is connected to a first check valve 220, the first check valve 220 is connected to the oil supply pipe 201, the hydraulic oil is capable of flowing from the oil supply pipe 201 to the cavity with non-rod 130 through the first check valve 220. The hydraulic oil is capable of flowing through the first check valve 220 to the cavity with non-rod 130, to make the piston rod 110 drive the load to move towards a side of the cavity with rod 120, to realize lifting the load, such as the aerial work platform and the like. The first check valve 220 is configured to prevent the hydraulic oil from flowing back to the oil supply pipe 201 from the cavity with non-rod 130 during a process of load lifting and static process, to make the load such as the aerial work platform be kept in the air and not descend, thus making the aerial operation be normally performed.

Referring to FIG. 1, it may be understood that the inlet of the proportional valve 400 is connected to a second check valve 600, and the second check valve 600 is connected to the oil supply pipe 201. The hydraulic oil is capable of flowing from the oil supply pipe 201 to the first check valve 220 through the second check valve 600. When the load such as the aerial work platform is lifted, the oil supply pipe 201 provides the hydraulic oil, the hydraulic oil passes through the second check valve 600 and then enters the cavity with non-rod 130 through the first check valve 220, to push the piston rod 110 to drive the load to lift. When the load descends and the switch valve 500 is opened, the hydraulic oil flows from the cavity with non-rod 130 to the inlet of the proportional valve 400, and the second check valve 600 is used for preventing the hydraulic oil from flowing back into the oil supply pipe 201 from the switch valve 500, to make the hydraulic oil enter the cavity with rod 120 and the oil return pipe 300 under pushing of the gravity of the load.

Referring to FIG. 1, it may be understood that a compensator 700 is connected between the outlet of the proportional valve 400 and the oil return pipe 300. Due to a characteristic of the counterbalance valve 200 itself, a flow rate passing through the counterbalance valve 200 is independent of a driving force of the load to the piston rod 110, so that the flow rate passing through the counterbalance valve 200 is substantially kept consistent when loads with different weights descend. However, the proportional valve 400 does not have this characteristic, so that the compensator 700 is added to ensure that the flow rate of the hydraulic oil passing through the proportional valve 400 is an approximately constant value under a same opening degree and does not change with fluctuation of a pressure of the load, thereby ensuring that the flow rate of the proportional valve 400 changes in proportion to an input electric signal, and thus speeds of loads with different weights during descending are capable of being better controlled.

Referring to FIG. 1, it may be understood that the emergency oil source 210 may adjust a pressure of the hydraulic oil provided to the oil return pipe 300 for adjusting pressures in the control port of the counterbalance valve 200 and the cavity with rod 120, to control a descending speed of the load such as the aerial work platform. The emergency oil source 210 may be constituted by an independent power supply and an independent hydraulic pump, to ensure that the emergency oil source 210 is capable of operating independently when a main power source or other devices fail and loses power. Start and stop and a rotational speed of the independent hydraulic pump are controlled by a controller. The descending speed of the load such as the aerial work platform may be controlled by controlling the opening degree of the counterbalance valve 200, to increase the safety during descending.

It may be understood that the proportional valve 400 is electrically connected to a controller 800. The controller 800 includes an obtaining module 801, a first control module 802 and a second control module 803. The obtaining module 801 is configured to obtain a movement speed of the telescopic hydraulic cylinder 100, and is capable of obtaining a retraction length of the load within a preset time period, then an actual speed is obtained by calculating according to the retraction length and the preset time period. The retraction length in the preset time period may be detected by a length sensor, for example, the retraction length is detected within an interval time ranging from 2s to 4s, and the actual speed is obtained by dividing the retraction length by the interval time. The first control module 802 outputs an electrical signal to control opening degrees of the proportional valve 400 and the switch valve 500 according to a movement speed signal of the telescopic hydraulic cylinder 100 obtained by the obtain module. The second control module 803 outputs an electrical signal to control start and stop of the emergency oil source 210 and a pressure of the output hydraulic oil according to the movement speed signal of the telescopic hydraulic cylinder 100 obtained by the obtain module.

In addition, an embodiment of the present disclosure further provides a control method of the emergency descent system for the aerial work platform which includes the following steps.
S101: obtaining a movement speed of the piston rod.
S102: controlling an opening degree of the proportional valve according to the movement speed of the piston rod; and controlling start and stop of the emergency oil source and a pressure of the hydraulic oil output by the emergency oil source according to the movement speed of the piston rod.

In some embodiments of the present disclosure, the control method includes the following steps.

Step one: adjusting, by a controller, an opening degree of the proportional valve 400 to minimum, and switching, by the controller, a switch valve 500 to an on position, then gradually increasing the opening degree of the proportional valve 400.

Step one: detecting, by the controller, a movement speed of the piston rod 110, and controlling, by the controller, the opening degree of the proportional valve 400 and start and stop of the emergency oil source 210.

In step S1, when a load is required to be retracted, the opening degree of the proportional valve 400 is firstly adjusted to the minimum, to prevent the excessive pressure change in the pipeline from impacting the proportional valve 400 and the compensator 700 when the switch valve 500 is opened, thereby prolonging a service life of the device.

In step S2, an actual speed of the piston rod 110 during descending is obtained, specifically, a length sensor may be provided on a boom of the aerial work platform, to collect a length of the boom in real time when the load descends, and output a length variation of the boom in an interval time, and then the actual speed during descending is calculated. Then, the actual speed is compared with a preset speed and performed a PID adjustment, and an adjustment variable data is output to control the opening degree of the proportional valve 400 and start and stop of the emergency oil source 210, to make the descending speed be consistent with the preset speed.

In some embodiments of the present disclosure, in the step S2, when the movement speed of the piston rod 110, that is, the descending speed of the load, increases with the increase of opening degree of the proportional valve 400, it indicates that the proportional valve 400 and the switch valve 500 work normally, the hydraulic oil in the cavity with non-rod 130 flows to the cavity with rod 120 through the proportional valve 400 and the switch valve 500, and it is not necessary to start the emergency oil source 210. Then, the opening degree of the proportional valve 400 continues being increased until the movement speed of the piston rod 110 reaches the preset value. When the opening degree of the proportional valve 400 is increased, but the movement speed of the piston rod 110 is zero or remains unchanged, it indicates that the proportional valve 400 and the switch valve 500 work abnormally and cannot be started or cannot be fully started, so that the hydraulic oil in the cavity with non-rod 130 cannot flow to the cavity with rod 120 through the proportional valve 400 and the switch valve 500 normally. Therefore, the emergency oil source 210 is started to gradually increase the pressure of the hydraulic oil flowing to the control port of the counterbalance valve 200 and the cavity with rod 120, to control the counterbalance valve 200 to be started, to make the hydraulic oil in the cavity with non-rod 130 flow to the cavity with rod 120 through the counterbalance valve 200 until the movement speed of the piston rod 110 reaches the preset value, so that the safety of the operation in case of failure of the proportional valve 400 and the switch valve 500 is ensured.

The embodiments of the present disclosure are described in detail above with reference to the drawings, but the present disclosure is not limited to the above embodiments, and various changes may be made without departing from a purpose of the present disclosure by a person having ordinary skill in the art.

What is claimed is:

1. An emergency descent system for an aerial work platform, comprising:
a telescopic hydraulic cylinder, provided with a piston rod inside for lifting a load, the piston rod dividing an interior of the telescopic hydraulic cylinder into a cavity with rod and a cavity with non-rod;
a counterbalance valve, an inlet of the counterbalance valve being connected to the cavity with non-rod, and an outlet of the counterbalance valve being connected to an oil supply pipe;
an oil return pipe, connected to the cavity with rod, the oil return pipe being connected to an emergency oil source which is used for providing hydraulic oil to the oil return pipe, and the oil return pipe being connected to a control port of the counterbalance valve; and
a proportional valve, an inlet of the proportional valve being connected to the cavity with non-rod, and an outlet of the proportional valve being connected to the oil return pipe.

2. The emergency descent system for the aerial work platform according to claim 1, wherein a switch valve is connected between the proportional valve and the cavity with non-rod for connecting and closing an oil path between the proportional valve and the cavity with non-rod.

3. The emergency descent system for the aerial work platform according to claim 1, wherein the inlet of the counterbalance valve is connected to a first check valve, the first check valve is connected to the oil supply pipe, the hydraulic oil is capable of flowing from the oil supply pipe to the cavity with non-rod through the first check valve, and the first check valve is configured to prevent the hydraulic oil from flowing back to the oil supply pipe from the cavity with non-rod.

4. The emergency descent system for the aerial work platform according to claim 3, wherein the inlet of the proportional valve is connected to a second check valve, the second check valve is connected to the oil supply pipe, the hydraulic oil is capable of flowing from the oil supply pipe to the first check valve through the second check valve, and the second check valve is configured to prevent the hydraulic oil from flowing back to the oil supply pipe from the switch valve.

5. The emergency descent system for the aerial work platform according to claim 1, wherein a compensator is connected between the outlet of the proportional valve and the oil return pipe.

6. The emergency descent system for the aerial work platform according to claim 1, wherein the emergency oil source is configured to adjust a pressure of the hydraulic oil provided to the oil return pipe to control an opening degree of the counterbalance valve.

7. The emergency descent system for the aerial work platform according to claim 2, further comprising a controller, wherein the controller is configured to perform the following steps: obtaining a movement speed of the piston rod; and controlling an opening degree of the proportional valve according to the movement speed of the piston rod, and controlling start and stop of the emergency oil source and a pressure of the hydraulic oil output by the emergency oil source according to the movement speed of the piston rod.

8. The emergency descent system for the aerial work platform according to claim 7, wherein the controller is further configured to control the switch valve to be an on position, before obtaining the movement speed of the piston rod, the steps further comprise: adjusting the opening degree of the proportional valve to minimum and switching the switch valve to the on position, and then gradually increasing the opening degree of the proportional valve.

9. The emergency descent system for the aerial work platform according to claim 8, wherein the controlling an opening degree of the proportional valve according to the movement speed of the piston rod comprises:
when the movement speed of the piston rod increases with an increase of the opening degree of the proportional valve, continuing increasing the opening degree of the proportional valve until the movement speed of the piston rod reaches a preset value.

10. The emergency descent system for the aerial work platform according to claim 8, wherein the controlling start and stop of the emergency oil source and a pressure of the hydraulic oil output by the emergency oil source according to the movement speed of the piston rod comprises:
when the opening degree of the proportional valve is increased, but the movement speed of the piston rod is zero or unchanged, starting the emergency oil source to gradually increase a pressure of the hydraulic oil flowing to the control port of the counterbalance valve until the movement speed of the piston rod reaches a preset value.

11. The emergency descent system for the aerial work platform according to claim 2, wherein the switch valve is a two-position, two-way and two-way cut-off switch valve.

12. A control method of the emergency descent system for the aerial work platform according to claim 1, comprising:
obtaining a movement speed of the piston rod;
controlling an opening degree of the proportional valve according to the movement speed of the piston rod; and
controlling start and stop of the emergency oil source and a pressure of the hydraulic oil output by the emergency oil source according to the movement speed of the piston rod.

13. The control method according to claim 12, wherein in the emergency descent system for the aerial work platform, a switch valve is connected between the proportional valve and the cavity with non-rod for connecting and closing an oil path between the proportional valve and the cavity with non-rod, and before the obtaining a movement speed of the piston rod, and the control method further comprises:
adjusting the opening degree of the proportional valve to minimum, and switching the switch valve to an on position, then gradually increasing the opening degree of the proportional valve.

14. The control method according to claim 13, wherein the controlling the opening degree of the proportional valve according to the movement speed of the piston rod comprises:
when the movement speed of the piston rod increases with an increase of the opening degree of the proportional valve, continuing increasing the opening degree of the proportional valve until the movement speed of the piston rod reaches a preset value.

15. The control method according to claim 13, wherein the controlling start and stop of the emergency oil source and a pressure of the hydraulic oil output by the emergency oil source according to the movement speed of the piston rod comprises:
when the opening degree of the proportional valve is increased, but the movement speed of the piston rod is zero or unchanged, starting the emergency oil source to gradually increase a pressure of the hydraulic oil flowing to a control port of the counterbalance valve until the movement speed of the piston rod reaches a preset value.
